(19) United States
(12) Patent Application Publication
(10) Pub. No.: US 2004/0198892 A1
(43) Pub. Date: Oct. 7, 2004

(54) Electron source and method for making same

(75) Inventors: Heinz H. Busta, Park Ridge, IL (US); David W. Boldridge, Oswego, IL (US); Ronald E. Myers, Aurora, IL (US)

Correspondence Address: STEVEN D WESEMAN, ASSOCIATE GENERAL COUNSEL, IP, CABOT MICROELECTRONICS CORPORATION, 870 NORTH COMMONS DRIVE, AURORA, IL, 60504, US

(73) Assignee: Cabot Microelectronics Corporation

(21) Appl. No.: 10/814,714

(22) Filed: Mar. 31, 2004

Related U.S. Application Data
(60) Provisional application No. 60/459,553, filed on Apr. 1, 2003.

(51) Int. Cl. C08K 3/04; C08K 3/34; C08K 3/40

(52) U.S. Cl. 524/495; 524/494; 524/492

(57) ABSTRACT

A field emitter source and method for making same. An x-ray and a high energy electron source is fabricated from the field emitter. The field emitter source composition comprises carbon black and a mixing medium. An alternative method of field emitter formulation includes providing a quantity of silica with the carbon black and a mixing medium. An x-ray source comprises a substrate and a carbon black field emitter composition provided along a surface of the substrate and an extraction grid to pull electrons from the field emitter film and a metal film biased at high voltage to accelerate the electrons. A conductive film is further provided along an upper support structure of the source, such that when the conductive film is struck by the accelerated electrons, the upper support structure converts the impinging high-energy electrons into x-rays. A high energy electron source is also disclosed similar to the x-ray source but without a conductive film and with appropriate apertures to facilitate egress of the high energy electrons.

### CROSS-REFERENCE TO RELATED APPLICATIONS

This patent application claims the benefit of U.S. Provisional Patent Application No. 60/459,553, filed on Apr. 1, 2003.

### FIELD OF THE INVENTION

The present invention is directed to field emission materials, compositions, structures, devices, and methods for making same. More particularly, the present invention is directed to methods and systems for fabricating a field emission structure and device. Aspects of the invention are particularly useful in providing a field emission-based large area x-ray source and a high energy large area electron source. Other aspects of the present invention are particularly useful where a cold electron source is desired such as in providing a flat panel display. However, aspects of the invention may be equally applicable in other scenarios as well.

### DESCRIPTION OF RELATED ART

Cold electron generation via field emission is of interest for a diverse group of applications ranging from miniature electron guns in CRTs, x-ray generation for catheter-type therapeutic treatment to large area displays. The field of vacuum microelectronics essentially started with the micro fabrication of gated molybdenum tips, for example the Spindt emitter. Then, these devices graduated to diamond and diamond like carbon (DLC) films to nanomaterials such as carbon nanotubes (CNTs).

In the technological field of field emission structures and devices, a microelectronic emission element, or a plurality (array) of such elements, is employed so as to emit a flux of electrons. This flux of electrons is emitted from one or more field emitters. The field emitters, sometimes referred to as “tips,” are specifically shaped to facilitate effective emission of electrons. Such tips may be conical-shaped or pyramidal-shaped in a surface profile.

Field emitter structures have wide potential and actual utility in microelectronics applications. For example, representative applications include electron guns, display devices comprising the field emitter structure in combination with photo-luminescent materials on which the emitted electrons are selectively impinged. Other representative applications include vacuum integrated circuits comprising assemblies of emitter tips coupled with associated control electrodes.

In certain known devices, a field emission tip is characteristically arranged in electrical contact with an emitter conductor and in spaced relationship to an extraction electrode, thereby forming an electron emission gap. With voltage imposed between the emitter tip and extraction electrode, the field emitter tip discharges a flux of electrons. The tip or tip array may be formed on a suitable substrate such as silicon or other semiconductor or conductive material. Associated electrodes may be formed on and/or in the substrate by conventional planar techniques to yield microelectronic devices.

Various field emitter types and technologies are known. For example, one such type of field emitter technology is the Spindt emitter. In a Spindt emitter, field emitters are formed by fabricating an electrode into a vicinity of a micrometer-sized molybdenum cone (Spindt emitter). Products based on such Spindt emitters present certain difficulties, both from a manufacturing and an operation standpoint. For example, Spindt emitters have an adverse aging phenomenon that takes place at the molybdenum surface.

In addition, various field emitter films and composites have been proposed. For example, by replacing the cones with diamond or diamond like films, certain improved performances have been suggested. However, such diamond and diamond-like films are generally expensive to deposit. As such, it is generally desirable to provide a less costly material that could achieve the same or roughly the same results at a reduced cost. It would also be generally desirable to avoid certain of the manufacturing difficulties normally associated with the fabrication of field emitters, such as depositing a field emitter composition over large areas of several square meters.

Aside from the interest in diamond-based field emitter technology, another popular area of interest includes the use of carbon nanotube emitters (CNTs). One advantage of using CNTs is that CNTs can be grown on substrates or grown on top of silicon cones. CNTs may also be mixed with thick film inks to form gated or ungated field emitters. There are, however, a number of disadvantages to using CNTs. For example, the adhesion of CNTs to a substrate is generally a weak adhesion. Therefore, the CNTs have a tendency to be pulled off of the substrate at elevated electric fields. Moreover, CNTs are also generally costly to fabricate. Therefore, it is cost prohibitive to fabricate large (e.g., of several square meters) displays, billboards, and electron sources (such as wide screen televisions, and large area x-ray or electron sources) utilizing CNTs.

It is also generally known that dielectric/carbon nano-composites have been fabricated wherein carbon is deposited using a Chemical Vapor Deposition (CVD) process. For example, work using a CVD process is described in Karabutov et al. “Substitution of Diamond with Insulator in Nanostructure Carbon Low-Field Emitter,” Proceedings of the 14^{th} International Vacuum Microelectronics Conference, University California Davis, page 277, (2001), which is incorporated by reference herein and to which the reader is directed for further information. In Karabutov et al., the authors suggest utilizing nanocomposites coated with a thin carbon film using a high temperature CVD process. However, one disadvantage of the Karabutov et al. process is that high processing temperatures, on the order of above 450 degrees C. are required. Such high processing temperatures pose certain problems. For example, using such high processing temperatures would not be desirable where a field emitter composition is deposited onto a flexible, plastic substrate.

There is, therefore a general need for a cost effective cold electron source. That is, there is a general need for a cost effective electron source having a low turn-on field, such as on the order of about 1 V/μm to about 20 V/μm. There is also a general need for a low cost field emitter, when compared to more costly field emitters, such as carbon nanotube-type or diamond based emitters. Also, because, at present, carbon nanotubes can be fabricated in only certain limited quantities, a field emitter source is required that can be readily obtainable. In addition, there is a general need for a cost effective cold electron source that can be fabricated without the manufacturing and/or production complexities of requiring high processing temperatures, such as temperatures on the order of 450° C. or higher.

### SUMMARY

According to an exemplary arrangement, a field emitter composition comprises a quantity of carbon black, and a quantity of a mixing medium. The quantity of the carbon black is dispersed in the mixing medium.

According to yet another exemplary embodiment, a method of processing a field emitter formulation comprises the steps of providing a quantity of carbon black, silica medium, and a mixing medium. The quantity of carbon black, silica medium and the mixing medium are mixed together to derive a field emitter formulation.

In yet another exemplary embodiment, an X-ray device is provided. The X-ray device includes a substrate and an electron emitter composition provided along a surface of the substrate. The field emitter composition comprises carbon black. A conductive film is provided along an upper support structure, such that when the conductive film is struck by impinging high-energy electrons emitted through a grid structure from the field emitter composition, the upper support structure converts the impinging high-energy electrons into x-rays. In yet another exemplary embodiment, a high energy electron source is provided.

These as well as other advantages of various aspects of the present invention will become apparent to those of ordinary skill in the art by reading the following detailed description, with appropriate reference to the accompanying drawings.

### BRIEF DESCRIPTION OF THE DRAWINGS

An exemplary embodiment of the present invention is described herein with reference to the drawings, in which:

FIG. 1 illustrates a flow chart for processing a field emitter formulation comprising carbon black dispersed in a mixing medium;

FIG. 2 illustrates a flow chart for processing a field emitter formulation comprising carbon black and silica dispersed in a mixing medium;

FIG. 3 illustrates Current versus Electric Field (I-E) curves of field emitter formulations processed in accordance with the flow charts illustrated in FIGS. 1 and 2, and a comparison I-E curve of a field emitter composition comprising CNTs;

FIG. 4 illustrates an x-ray source comprising a field emitter composition processed in accordance with one aspect of the present invention; and

FIG. 5 illustrates an alternative arrangement of a top plate configuration for a high energy electron source.

### DESCRIPTION

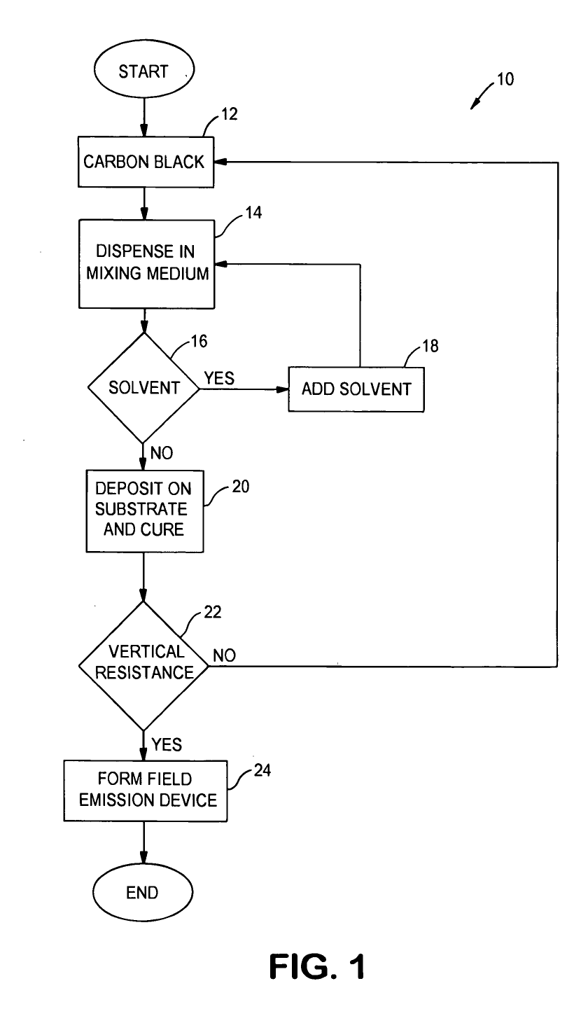

FIG. 1 illustrates a flow chart 10 for processing a cold electron emitter composition comprising carbon black particles dispersed in a mixing medium. Preferably, this mixing medium comprises a polymer matrix. At first Step 12, carbon black particles are provided. Such carbon black particles could comprise relatively inexpensive particles such as a feedstock for tires, inks, or the exhaust from a vehicle, such as diesel fuel exhaust. Such carbon black particles could have various particle sizes, particle shapes, surface areas, specific gravities and may be provided with or without surface treatments.

Examples of effective carbon blacks include, but are not limited to amorphous carbon blacks (such as grade/types designated as furnace blacks, specifically including Vulcan and Monarch blacks manufactured by Cabot Corporation). Additional carbon blacks include Conductex 975 Ultra and Conductex SC Ultra (Columbian Chemicals Co.). One preferred carbon black is Vulcan XC72R, however, other types of carbon blacks could also be used.

At Step 14, the carbon black is dispersed into a mixing medium. In one preferred arrangement, the mixing medium comprises a positive photoresist, such as Microposit S1818 from Shipley Company. Numerous other mixing media may be used at Step 14 and that are effective as binders or matrices for these carbon black formulations. Other such mixing media could include, but are not limited to: cresol novolak resin (for example, Microposit S1805, and Microposit FSC-M; all from Shipley Company L.L.C., of Marlborough, Mass.).

Other mixing media could include epoxies, polyurethanes, polyacrylates, polyesters, polyimides, polysiloxanes, and siloxane-hydrocarbon polymers such as the B-staged divinylsiloxane-bisbenzocylobutenes (CYCLOTENE; Dow Chemical Company). In one preferred arrangement, such a mixing medium could comprise a flowable oxide (such as the flowable oxide FO×17 from Dow Corning). In another preferred arrangement, such a mixing medium could comprise a spin-on glass (SOG). SOG materials may be of several types including, but not limited to, silicate-based compounds, organosilicon compounds and dopant-organic compounds. One such SOG having utility in one aspect of the present invention is Accuglass T-11, and the like, from Honeywell. Alternatively, such a mixing medium could comprise a polymer that is converted into diamond by heat treatment, such as a diamond based polymer composition provided by Cenymer, of Longmont, Colo. The choice of a given mixing medium will depend upon the desired viscosity, end-use temperature requirements, and the ability of the mixing medium to enhance the field emission of a given formulation.

At Step 16, process 10 may include the step of adding an organic solvent to the formulations. Adding an organic solvent at Step 18 may be premised on the decision of modifying or controlling formulation viscosity. For example, a formulation viscosity may influence the properties of the resulting film (e.g., film thickness, film uniformity, quality of dispersion, film planarity, etc.). Examples of such organic solvents include, but are not limited to: mesitylene, xylene, toluene, propylene glycol monomethyl ether acetate, acetone, acetonitrile, N-methyl pyrrolidone, alcohols such as isopropyl alcohol, and other like solvents.

In one arrangement, during the dispersing Step 14, either a photosensitive or non-photosensitive polymer formulation may be used. For example, a preferred photosensitive polymer formulation is Microposit S1818 (Shipley Company) or CYCLOTENE 4022 (Dow Chemical Company). Examples of preferred non-photosensitive polymer formulations include Microposit FSC-M (Shipley Company) and CYCLOTENE 3022-35 (Dow Chemical Company).

The CYCLOTENE polymer formulations have several advantageous characteristics. For example, the CYCLOTENE 3022-35 polymer formulation has a generally low viscosity (less than about 15 cps at 25° C.), resulting in fairly thin cured films (e.g., 1-2 microns spin-coated at 5,000-1,000 rpm), and resulting in a high planarization efficiency. The viscosity (at 25° C.) of such CYCLOTENE and other polymer formulations of the present invention is preferably less than about 1500 cps and most preferably less than about 250 cps. The use of a relatively low viscosity mixing medium facilitates the dispersion of the other components of the formulation and therefore provides more consistent field emission properties. The lower viscosity also allows spreading the formulation onto a substrate in a thinner and more uniform manner.

At Step 20, the electron emitter formulation is deposited onto a substrate and the formulation is then cured. For example, because the electron emitter composition can be efficiently applied to a surface area, such a substrate could comprise a flat substrate having a generally large area. For example, the large area could be on the order of 1 ft², or larger. Such a substrate could also comprise a surface having a non-uniform structure, such as a curved surface area. In one arrangement, the curved surface area could comprise an outer or an inner surface of a tube. In another arrangement, the substrate could comprise a flexible substrate. For example, in one arrangement, the flexible substrate could comprise a plastic sheet, such as the plastic sheet that is used for flexible electronic component interconnects. As those of skill in the art will recognize, other suitable flexible substrates could also be used.

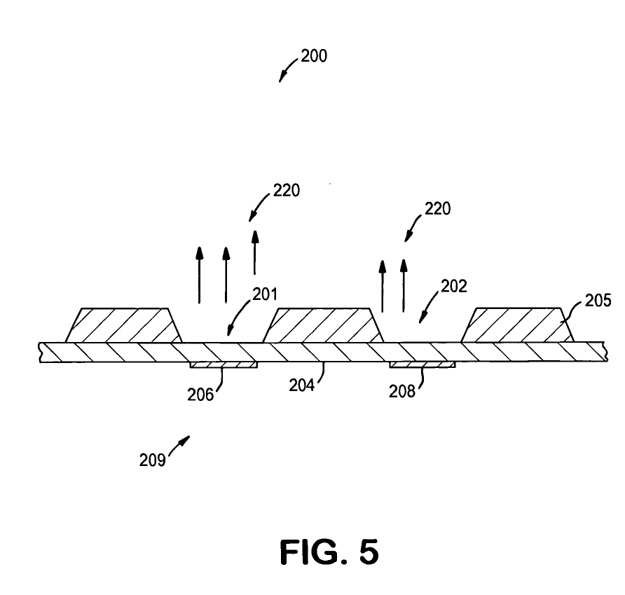

The use of photosensitive mixing media or other patterning processes can be used to dispose the field emitter formulation into a desired pattern such as a pixel array. Given that the field emitter properties of these formulations require applied voltage to obtain an electron current, it is possible to selectively pattern these field emitters onto one or more metal layers of an integrated circuit. This would provide a cost effective and integrated approach to deliver field emission functionality into a device. See e.g., Wei Zhu, Editor, Vacuum Microelectronics, Chapter 5, FIG. 5.38, p.234, John Wiley & Sons (2001).

Additionally, at Step 20, the polymer formulations should be curable to a relatively impermeable and solvent/chemical resistant film with low outgassing properties in vacuum. Alternatively, the polymer formulations may be either non-photosensitive or photosensitive (i.e., a photoresist). The polymer formulations may be cured by various methods, including radiation and thermal curing.

At Step 22, the electron emitter formulation is evaluated for vertical resistance. That is, the formulation is evaluated to see if the formulation has reached a particular desired conductivity threshold. One method of evaluating vertical resistance includes placing a rounded probe tip on top of the film. This probe tip is connected to an Ohm meter. Another probe tip is connected to the conductive substrate onto which the field emitter film composition has been deposited. Preferably, the Ohm meter should register a resistance below the 1 kilo-Ohm range to thereby register an acceptable vertical resistance. As those of skill in the art will recognize, this is just one type of acceptable vertical resistance value and other types of values may also be desired.

If the formulation does not have the desired vertical resistance, additional carbon black may be added at Step 12. Furthermore, additional solvent may also be added at Step 18. Then, the re-formulated composition may be remixed at Step 14. The resulting reformulated matrix is deposited on a substrate at Step 20, cured, and then re-checked for vertical resistance at Step 22.

Vertical resistance is one important aspect of field emitter compositions. For example, one reason that vertical resistance is evaluated is that the electrons from the conductive substrate will travel vertically through the film to the emitter-vacuum interface. Therefore, the field emitter films do not need to (but could) possess lateral conductivity so long as enough emission sites are available in the vertical direction to achieve a certain desired vertical resistance.

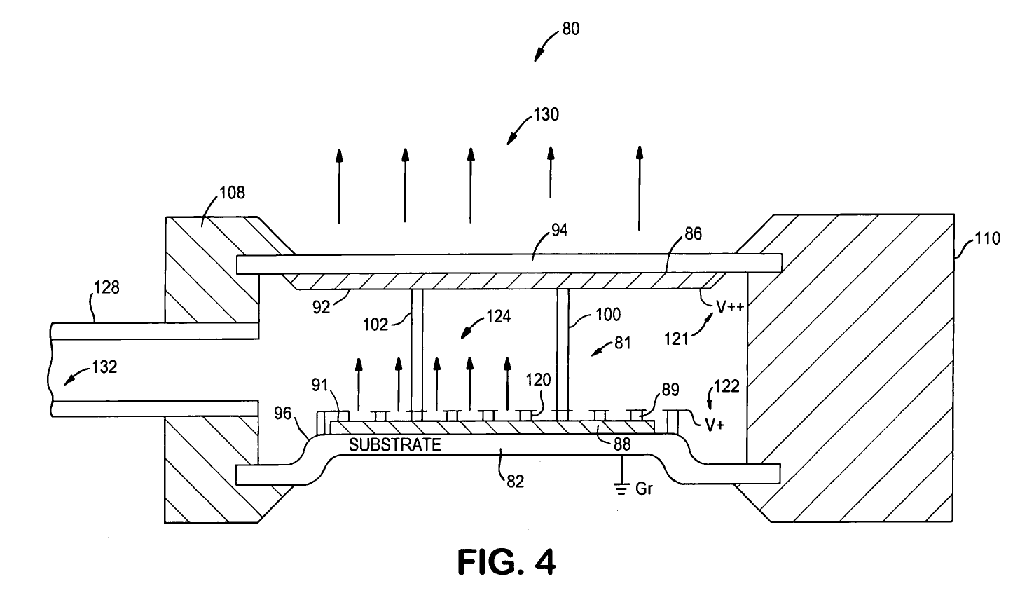

At Step 24, field emission devices or field emission systems may be fabricated using the field emitter substrate processed in Step 22. Two types of field emitting devices that could be made at Step 24 are described with reference to FIGS. 4 and 5 and explained in detail below.

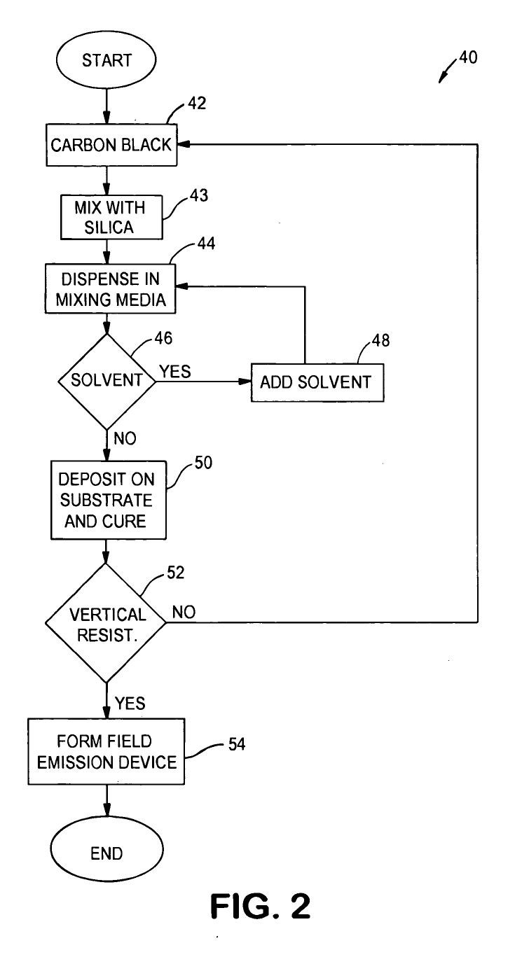

FIG. 2 illustrates a flow chart 40 for processing an electron emitter composition comprising a carbon black and a silica mixture dispersed in a mixing medium. The steps in flow chart 40 are generally similar to the steps described and explained above with reference to FIG. 1.

For example, at Step 42, carbon black is provided. Types and properties of preferred carbon blacks are described above. Then, at Step 43, the carbon black is mixed with a silica powder. Examples of preferred silicas include, but are not limited to: fumed silicas (such as L-90, LM-130, LM-150, M-5, HS-5, all Cab-O-Sil silicas, primarily differing in surface area, available from Cabot Corporation). A silica, such as the L-90, is preferred because of its relatively low surface area.

These samples that are mixed at Step 43 maybe prepared such that the mixture will have a specific weight ratio. Examples include weight ratios of 1:1, 1:2, and 2:1 of C:SiO₂, but are not limited to these ratios.

At Step 44, the carbon black-silica mixture is dispersed in a mixing medium. In one arrangement, after the mixing Step 44, either a photosensitive or non-photosensitive polymer formulation may be used. For example, a preferred photosensitive polymer formulation is Microposit S1818 (Shipley Company) or CYCLOTENE 4022 (Dow Chemical Company). A preferred non-photosensitive polymer formulation includes Microposit FSC-M (Shipley Company) or CYCLOTENE 3022-35 (Dow Chemical Company). CYCLOTENE polymer formulations have several advantageous characteristics including: low viscosity (<15 cps at 25 degrees C.), thin cured films (1-2 microns spin-coated at 5,000-1,000 rpm), and high planarization efficiency.

At Step 50, this formulation is deposited onto a substrate and cured as described above. The cured formulation may then be planarized, preferably using chemical mechanical planarization (CMP) which is a process that combines a chemically reactive slurry and mechanical force as a means to planarize a surface.

One advantage of adding silica to the carbon black in Step 43 in FIG. 2 is that this tripartite carbon black/silica/mixing media composition forms a nanotechnology equivalent of a triple junction. Triple junctions, which generally occur at a three-way interface of a conductor, an insulator, and a vacuum, are known to those skilled in the art to show a certain degree of field emission enhancement.

Then, at Step 52, the formulation is evaluated for vertical resistance. As described above, if the formulation does not have the desired vertical resistance, additional carbon black and solvents may be added at Step 46. The formulation may then be re-mixed at Step 44.

At Step 54, emission devices or systems may be fabricated using this formulation. Two such cold field emitting devices will be described with reference to FIGS. 4 and 5.

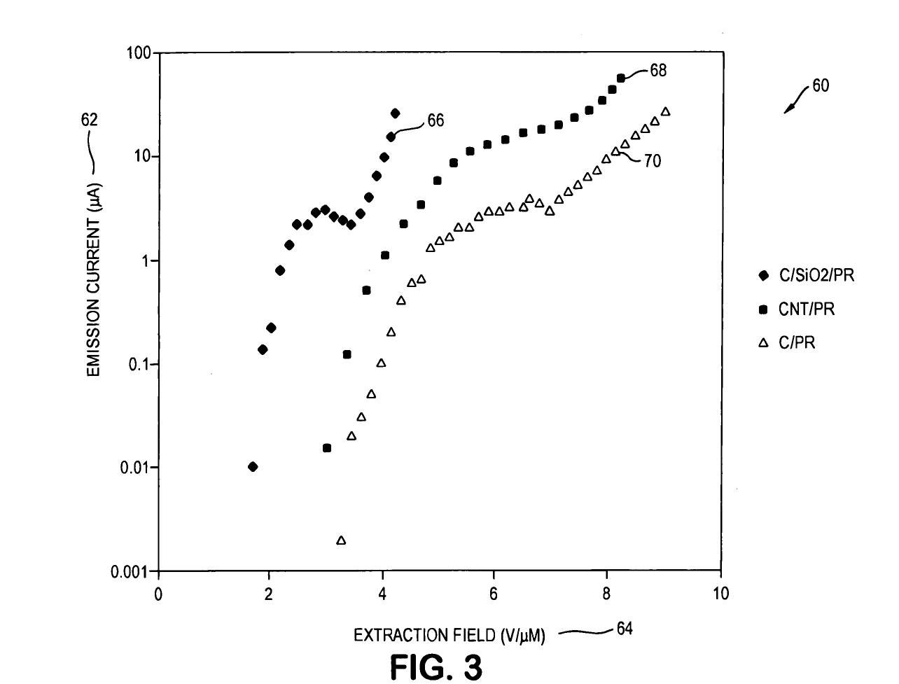

Performance of a carbon and carbon/silica emitter was compared with an emitter formulation comprising CNTs and a mixing medium comprising a photoresist such as Microposit S1818. Initial results of this comparison are illustrated in FIG. 3. FIG. 3 illustrates Current versus Electric Field (I-E) graphs 60. Graph 60 illustrates Emission Current (μA) as a function of extraction field (V/μm) 64. As shown in FIG. 3, three I-E curves are provided: a first for a Carbon Black-SiO₂-Photoresist (PR) formulation 66, a second for a Carbon Nanotube—PR formulation 68, and a third for a Carbon Black-PR formulation 70.

To compare emission results with CNTs, equal amounts of CNTs as compared to carbon and Carbon/SiO₂ were mixed with photoresist and prepared in the same manner as discussed above. After spinning, the test samples were baked in air at 120° Celsius for 10 minutes. Then, a small area of the material, an area on the order of approximately about 1 cm², was removed at one of the comers of the test samples. The small area of the material was removed using clean room tissue immersed in acetone. The exposed Copper surface was then used to contact the emitter via a tungsten probe tip mounted on an XYZ manipulator.

Emission testing was performed in an ion-pumped custom built vacuum chamber at pressures ranging from approximately 10⁻⁶ to approximately 10⁻⁸ Torr. After placing the emitter contact onto the exposed Copper surface of the test sample, the anode, also mounted on an XYZ manipulator, was brought into contact with the sample. In this manner, the sample was checked to determine if the field emitter film possessed conductive properties. The anode was then lifted until contact was interrupted, thereby defining a d=0 position. The anode distance was then adjusted via the Z micrometer of the XYZ manipulator, typically ranging from 25 to 150 micrometers. Since touching the emitter with the 3 mm diameter anode probe could potentially damage the surface, the probe, after pull-back, was then moved via the X or Y micrometers by a distance of at least one diameter away from its initial position. With the above described method, the accuracy of distance determination is about ±10 micrometers.

As one can see from the graph in FIG. 3, the extraction field or “turn-on field” 64 for the C/SiO₂/PR sample 66 and the C/PR sample 70 range from about 2 V/μm to about 4 V/μm. As those of skill in the art will recognize, the turn on field is generally understood as the extraction field when an emission current 62 on the order of approximately 10 nanoamps is achieved.

As shown by FIG. 3, the C/SiO₂/PR sample 66 appears to have the lowest turn on field. This C/SiO₂/PR sample 66 also appears to have a generally pronounced peak in its I-E curve. The other two samples, samples 68 and 70, show what is believed to be a saturation region. It is generally known that isolated CNTs (i.e., CNTs not mixed with a photoresist) have a tendency to show a similar behavior and emission is attributed to an adsorbate enhanced emission, followed by a saturation region. Such a saturation region is generally associated with a removal of adsorbates. The saturation region is normally followed by a region of increasing emission from the clean surface. See e.g., Wei Zhu, Editor, Vacuum Microelectronics, Chapter 6, FIG. 6.13, John Wiley & Sons (2001).

FIG. 4 illustrates an embodiment of a field emitter structure 80 that incorporates aspects of the present invention. More particularly, this field emitter structure 80 comprises a field emitter composition 88 such as the composition made in accordance with the process illustrated in either FIG. 1 or FIG. 2. As illustrated in FIG. 4, the field emitter structure 80 also comprises a substrate 82. Such a substrate could comprise a metal plate fabricated from Al, Cu, or stainless steel.

Returning to FIG. 4, preferably, field emitter composition 88 comprises a field emitter composition fabricated in accordance with the methods illustrated in either FIG. 1 or FIG. 2, and is provided along a top surface 96 of the substrate 82. This field emitter composite may be deposited along this surface 96 by spin coating or spraying. After curing the deposited composite 88, the surface of said cured composite film may be further planarized, preferably by chemical mechanical planarization (CMP). A grid structure 91 may be placed over the emitter film 88. The grid structure, which is a generally known grid structure containing a plurality of grid apertures 120, resides on a plurality of insulating portions 89. For those skilled in the art, it will be realized that the grid structure 91 may be fabricated from Cu, stainless steel, or other like metals. The insulator portions 89 may be fabricated from a polyimide tape or other appropriate materials. A bottom surface of the insulating film can also contain an adhesive so that the grid structure 91 can be attached to the emitter material. Alternatively, the grid structure 91 may be fabricated on top of the emitter composition 88 by depositing a layer of insulator several microns thick, followed by metal deposition and a photolithographic step to define the plurality of apertures. The insulator material residing under the photodefined apertures may then be removed by etching and the photoresist on top of the metal film is also removed.

The field emitter structure 80 includes two optional insulator structures 100 and 102. These optional insulator structures 100 and 102 extend in a vertical direction away from the top surface of the grid 91, thereby providing a certain degree of mechanical stability and/or mechanical support to an upper support structure 94. Such insulator structures may or may not be required, depending on the type of field emitter structure. For example, where a surface of the x-ray source has a surface area on the order of about 1 ft², by choosing the appropriate thickness of the substrate structure 82 and upper support structure 94, these spacers might not be necessary. For devices having a larger surface than about 1 ft², these spacers might be included. Although only two spacers are illustrated in FIG. 4, it should be understood that other spacer arrangements and/or configurations may also be used such as a spacer arrangement including more than two spacers.

The lengths of the spacers also depend on the operating voltages, increasing in length as the voltage increases from 20 kV to 1 MV or above, so that electrical breakdown does not occur.

The upper support structure 94 resides along the top surface 86 of a conductive layer 92. Preferably, this upper support structure 94 extends along the length of the substrate 82. In one arrangement, the upper substrate comprises a low atomic mass material. Such a low atomic mass material could include diamond, glass, or a combination of such like materials. Preferably, the conductive layer 92 is provided along a bottom surface of the upper support structure 94. This conductive film may comprise Mo, Cu, W, or other like material and could be deposited at a depth of about 1 to about 15 μm, depending on certain desired operational characteristics of the device 80. For example, in one arrangement, the conductive film may be chosen based on the operational voltage of the x-ray device. This film, when struck by a flux of impinging high-energy electrons 124, will convert a portion of the electron flux (from about 0.1 to about 3 percent) into x-rays 130.

In one arrangement, the upper support structure 94 and the substrate 82 are encapsulated by an insulating medium illustrated as insulating medium 108, 110. Such an insulating medium could comprise a machinable ceramic, BN, or other like material. This insulating medium surrounds the field emitting device 80.

A pumping port 132 is provided near the insulating medium 108. Rather than encapsulate the entire device 80 in a vacuum, here the device 80 may be continuously pumped via pumping port 132. This pumping process will tend to increase the operational life of the device 80 since any outgassing species coming from the grid 91, the spacers 100 and 102, the conductive layer 92, and elements of the device 80 can in essence be pumped away from an internal device cavity 81. Therefore, these outgassing species will be essentially prevented from accumulating inside the internal device cavity 81, thereby avoiding the increase in pressure inside the device cavity 81. Increased pressure may result in vacuum flashover events. In other words, since more gas molecules may be struck by the electron flux 124, this may cause conductive ions to form.

In one method of device operation, impinging high-energy electrons are created by applying a positive voltage V⁺ 122 with respect to layer 88 and the substrate 82 to the metallic layer 90 of grid 91. The substrate 82 is maintained at ground potential. Typical values of voltage V⁺ 122 might range from 100 to 1000 V. Such voltage values will depend, to a certain extent, on the specific geometry of the extraction grid 91. A higher voltage V⁺⁺ 121 is applied to layer 92. Depending on the application and the type of x-rays to be generated, i.e., soft x-rays versus high energy x-rays, this voltage V⁺⁺ 121 may range from 20 kV to several mega volts.

Positive voltage V⁺ 122, termed an extraction voltage, pulls or extracts electrons 124 from the field emitter layer 88. These extracted electrons 124 are then extracted through the various apertures 120 in the grid 90. At this point, the extracted electrons 124, which may be characterized a flux of electrons, are accelerated towards the conductive layer 92. At the conductive layer 92, the accelerated electrons 124 are converted into x-rays as described above. The x-rays then penetrate support layer 94 and exit the device as x-rays 130. These x-rays 130 are then available for various applications including x-ray imaging, sterilization,security inspection, water treatment, etc.

Various configurations of the upper support structure 94 may be utilized. For example, in one arrangement, the upper support structure 94 may be modified to achieve a large area high energy electron source. For example, one such alternative high energy electron source is illustrated in FIG. 5.

FIG. 5 illustrates a top plate assembly 200. This top plate assembly 200 comprises a support plate 205 having a plurality of apertures 201, 202. This support plate 205 resides adjacent to layer 204. The layer 204 may be fabricated from beryllium, diamond, or other low atomic mass materials that are generally known to those skilled in the art to be good electron transmitting media. Under this layer 204, in the regions under the apertures 201, 202, a metallic grid layer 209 is deposited. This grid 209, which comprises a plurality of grid portions 206, 208, may be about 100 to about 600 Angstroms thick.

One purpose of this thin grid 209 is to be able to apply the high accelerating voltage V⁺⁺ for the electrons coming from grid 91 in FIG. 4. The high energy electrons penetrate the metallic grid portions 206 and 208 of the grid 209, also penetrate layer 204, and can then exit the apertures 201, 202 of the top plate assembly 200 support plate 205. These emitted high energy electron rays 220 can then be used for certain applications, including food sterilizations, removal of odorous fumes from waste water, etc.

Exemplary embodiments of the present invention have been described. Those skilled in the art will understand, however, that changes and modifications may be made to these embodiments without departing from the true scope and spirit of the present invention, which is defined by the claims.

We claim:

1. A field emitter composition comprising:
a quantity of carbon black; and
a quantity of a mixing medium;
wherein said quantity of carbon black is dispersed in said mixing medium.

2. The composition of claim 1 wherein said mixing medium comprises a polymer.

3. The composition of claim 1 wherein said mixing medium comprises a photoresist.

4. The composition of claim 1 wherein said field emitter composition is defined in a desired pattern.

5. The composition of claim 1 wherein said mixing medium has a viscosity of less than approximately 1500 cps.

6. The composition of claim 1 wherein said mixing medium has a viscosity of less than approximately 250 cps.

7. The composition of claim 1 further comprising an organic solvent, said organic solvent providing a desired viscosity to said field emitter composition.

8. The composition of claim 1 wherein said field emitter has an extraction field from about 1 V/μm to about 20 V/μm.

9. The composition of claim 1 wherein said carbon black comprises diesel fuel exhaust.

10. The composition of claim 1 wherein said mixing medium comprises a flowable oxide.

11. The composition of claim 10 wherein said flowable oxide comprises spin-on-glass.

12. The composition of claim 4 wherein said field emitter forms part of an integrated circuit.

13. The composition of claim 1 wherein said field emitter composition is disposed on a substrate surface.

14. The composition of claim 13 wherein said substrate surface is planarized utilizing a chemical mechanical polishing step.

15. The composition of claim 13 wherein said substrate surface is a non-planar surface.

16. The composition of claim 1 wherein said mixing medium comprises a polymeric precursor to diamond like carbon.

17. The composition of claim 1 wherein said field emitter comprises a quantity of silica dispersed in said mixing medium.

18. A method of processing a field emitter formulation comprising the steps of:
providing a first quantity of carbon black;
providing a second quantity of a mixing medium;
mixing said first quantity of carbon black and said second quantity of said mixing medium to derive said field emitter formulation.

19. The method of claim 18 further comprising providing a third quantity of silica.

20. The method of claim 18 further comprising the step of measuring said field emitter formulation for a desired vertical resistance.

21. The method of claim 18 wherein said mixing medium comprises a photoresist.

22. The method of claim 18 wherein said mixing medium comprises a non-photoresist.

23. The method of claim 18 further comprising the step of curing said field emitter formulation.

24. The method of claim 18 further comprising the step of applying said field emitter formulation onto a substrate.

25. The method of claim 24 wherein said substrate comprises a conductive material.

26. The method of claim 24 wherein said substrate has a planar surface.

27. The method of claim 24 wherein said substrate has a non-planar surface.

28. The method of claim 24 wherein said substrate comprises a flexible substrate.

29. An X-ray source comprising:
a substrate;
a field emitter composition provided along a surface of said substrate, said field emitter composition comprising carbon black,
a conductive layer provided along an upper support structure;
such that when said conductive layer is struck by impinging high-energy electrons emitted from said field emitter composition, said upper support structure converts said impinging high-energy electrons into x-rays.

30. The invention of claim 29 wherein a grid is provided between said upper support structure and said conductive layer.

31. The invention of claim 29 wherein said carbon black is dispersed in a mixing medium.

32. The invention of claim 29 wherein said conductive layer comprises Mo, Cu, W, or other like material.

33. The invention of claim 29 wherein said upper support structure comprises a low atomic mass material.

34. The invention of claim 29 wherein said emitter composition further comprises silica.

35. A high energy electron source comprising:
a substrate;
a field emitter composition provided along a surface of said substrate, said field emitter composition comprising carbon black;
an upper support structure comprising a plurality of apertures;
wherein said structure also comprises an electron transparent film and also comprises a metallic grid;
wherein energizing said metallic grid attracts electrons emitted from said field emitter composition.
